(19) United States
(12) Patent Application Publication
(10) Pub. No.: US 2014/0084227 A1
(43) Pub. Date: Mar. 27, 2014

(54) Motorized vertically adjustable lifting table, for example for use in body work construction in the motor vehicle industry

(71) Applicant: SOPAP AUTOMATION SAS, TOURNES (FR)

(72) Inventors: Andre TUNKERS, Dusseldorf (DE); Francois ROTA, Elan (FR)

(73) Assignee: SOPAP AUTOMATION SAS, TOURNES (FR)

(21) Appl. No.: 14/034,713

(22) Filed: Sep. 24, 2013

(30) Foreign Application Priority Data
Sep. 24, 2012 (DE) 10 2012 018 809.9

(51) Int. Cl. B66F 7/06

(52) U.S. Cl. CPC B66F 7/0641
USPC 254/124

(57) ABSTRACT

The invention relates to a motorized vertically adjustable lifting table, for example for use in body work construction in the motor vehicle industry. It is shown how a lifting table of this kind can be designed to be operationally reliable in the case of a correspondingly designed configuration for the corresponding movement profile of the load pick-up body.

### CATEGORY

The invention relates to a motorized vertically adjustable lifting table for example for use in bodywork construction in the motor vehicle industry.

### PRIOR ART

Belonging to the prior art are lifting tables which adjust the height of the load pick-up body relative to a frame-like underframe by means of cylinders or spindle drives. Load pick-up bodies and underframe are thereby connected to one another through scissor-type guide rod elements wherein the scissor-type guide rod elements are connected to one another for pivotal movement in their approximately central longitudinal area by pivotal axes. With one type of construction, for example, a pair of guide rods mounted at one end of the underframe is coupled to the underframe with pivotal movement whilst the other pair of guide rods is guided by rollers in rails of the underframe. The adjustment is carried out by piston-cylinder units.

Other types of construction use as guide rod elements guide rod elements arranged singly or in multiples in the manner of Nuremburg scissors through which the load pick-up body can be vertically adjusted relative to a frame-like underframe.

It is also known to arrange several such scissor-type mounted guide rod elements next to one another in the longitudinal axial direction of the underframe and to adjust them in synchronization in order to lift and lower the load pick-up body.

Unfavourable in numerous types of construction is the low tilt stability, particularly when heavy loads are to be moved, for example vehicle bodies in the production line in the motor vehicle industry.

Also known are lifting tables which have guide rod elements which criss cross like scissors and which extend between the load pick-up body and the frame-type underframe wherein a middle lifting column is to lift and lower the load pick-up body.

In bodywork construction in the motor vehicle industry there is often a requirement that such lifting tables are to be moved when transporting bodywork parts on pallet trucks in order to pass down the production line, wherein there is also a requirement to pick up the load each time in different vertical areas and set it down on a different level for removal.

### PROBLEM

The invention is concerned with the problem of providing a motorized vertically adjustable lifting table which can be used with particular advantage in bodywork construction in the motor vehicle industry wherein with a high tilt stability the movement profile required each time during the lifting displacement can be structurally predetermined.

### SOLUTION

This problem is solved through the features provided in claim 1.

### SOME ADVANTAGES

The frame-like load pick-up body has guide rods which are assigned to the underframe and connect the end areas together for pivotal movement so that in the one end area of the lifting table on at least each side, thus opposite one another, there are two guide rod elements which are spaced out on the relevant longitudinal side, and on the opposite end region of the lifting table on each side there is at least one such guide rod element, and the guide rod elements are coupled to the cross supports which are longitudinally displaceable and which are vertically movable in the longitudinal axial direction of the frame-like underframe. This means that the lifting table according to the invention is mounted at its one end region of the load pick-up body and underframe on each longitudinal side each by a parallelogram guide rod gearing and on the opposite end region on each longitudinal side at least by one such guide rod. A great tilt stability is achieved thereby without cross bars and without the middle part of the lifting table. Furthermore there is the possibility when lifting the table to reach a position, that the rotational axis or axes of the load pick-up means which connect the relevant guide rods here to reach a position in which self-locking is obtained so that in the absence of an energy supply for a drive motor the load cannot drop down.

Furthermore the possibility exists of arranging at each end section of a lifting table and on each longitudinal side a parallelogram rod gearing of this type which consists on each longitudinal side of spaced guide rod elements of equal size running parallel to one another and connecting the frame-like underframe with pivotal movement to the frame-like load pick-up body.

A particular advantage is achieved in that in the space between the load pick-up body and the underframe there are drive bodies which are connected in one piece with the longitudinally displaceable transverse supports. These drive bodies have at least one slide follower body, more particularly a rolling bolt which engages in each, in particular curved, slide recess of a gear body which is mounted between the two drive bodies. If this gear body is motor-driven, more particularly pivoted in the one or other direction, the slide follower bodies, more particularly the rolling bolts, are thereby moved correspondingly. Since these slide follower bodies are connected integral with the drive bodies, this movement of the gear body has the result that the drive bodies are moved either up to or away from one another, which through the connection of the drive bodies to the cross supports and the bearing assemblies connected therewith results in a corresponding pivotal movement of the guide rod elements and consequently a lifting or lowering movement of the load pick-up body.

More advantageously the movement profile, thus the initial acceleration, where applicable the lifting or lowering speed which remains the same or approximately the same, and the braking deceleration are copied and thus determined form-wise during lifting or lowering through corresponding configuration of the slide recesses. This means that these slide recesses need not necessarily be circular arcs, but can have a different mathematical configuration, are to be configured depending on the desired movement profile initial acceleration, speed and braking. Particularly in the case of heavy loads, for example complete vehicle bodies in the motor vehicle construction industry, impact in the end regions either against the underframe or on other device parts is thereby avoided.

### FURTHER INVENTIVE CONFIGURATIONS

Further inventive configurations are described in claims 2 to 18.

Claim 2 describes a particularly advantageous embodiment of the invention since the movement profile of the load pick-up body can be determined hereby—as described—through a corresponding configuration of the slide recesses.

Claim 3 describes for this further instruction for the technical and scheduled operations.

With claim 4 the curved slide recesses are arranged eccentric relative to one another in relation to the rotational center of the drive motor, for example a drive shaft of the drive motor.

Claim 5 describes a further advantageous embodiment of the invention which also applies for claim 6. With the configuration according to claim 6 the slide follower bodies can engage through the slide recesses so that a particularly favourable and reliable force transmission is produced from the drive motor via the slide drive to the drive bodies and thus to the guide rod elements.

With the configuration according to claim 7 the slide follower bodies which engage in the curved slide recesses are designed as pins which engage in the slide recesses with positive locking but smooth running.

With a preferred embodiment according to claim 8 the slide follower bodies are designed as rolling bolts mounted in rolling bearings and which engage in the curved slide recesses with positive locking but smooth running.

Particularly advantageous is an embodiment in which the gear body is designed as a plate. Such a gear body can not only be manufactured favourably but also enables a space-saving fitting in the region of the underframe of the lifting table.

With the plate-shaped configuration according to claim 10 the gear body is mounted on opposite sides restricted through flat faces and arranged horizontally relative to the installation floor in the space between the frame-type underframe and the vertically movable load pick-up body, preferably approximately in the upper plane of the underframe, so that the gear body takes up very little space and is not an obstruction.

Also the drive bodies are designed plate-shaped according to claim 11 and are each coupled functionally or materially in one piece with cross supports associated with frame parts of the underframe, wherein these frame parts or cross supports are assigned to the bearing assemblies of the underframe and thus also the guide rod elements so that a favourable force introduction is produced which enables a deceleration- and the best possible play-free and slip-free transfer of the movements of the drive body to the guide rod elements.

It is particularly advantageous if the gear body is mounted parallel to the drive body and above same in the space between spaced longitudinal beams of the underframe. This enables a particularly compact method of construction so that the space between the load pick-up body and the underframe can be kept free of installation parts for housing the drive motor.

Claim 13 describes an advantageous solution for this.

Claim 14 describes a preferred embodiment in which the plate-shaped drive bodies are connected to cross supports which are vertically movable in opposite directions with the bearing assemblies in longitudinal guides of the frame-like underframe in the longitudinal axial direction thereof.

Claim 15 describes a further alternative solution in which in all four end regions of the load pick-up body on each longitudinal side thereof and thus one each longitudinal side of the underframe there are two guide rod elements each spaced to form a parallelogram gearing on each longitudinal side of the lifting table. Thus not only a great stability but also a great anti-tilt security of the lifting table is thereby achieved for heavy and heaviest loads.

Claim 16 describes a further advantageous embodiment. If a solution according to claim 17 is selected then a smooth-running but secure and rectilinear guide of the bearing assemblies in the longitudinal axial direction of the lifting table is achieved.

With the embodiment according to claim 18 the gear body is designed in plan view substantially rectangular with somewhat cut-off or finished regions wherein in these corner regions the curved slide recesses are arranged opposite and off-set relative to one another.

The invention is shown in the drawing—partly diagrammatically—by way of example using a lifting table, as can be used with particular advantage for example in vehicle body construction in the motor vehicle industry.

The drawings show:

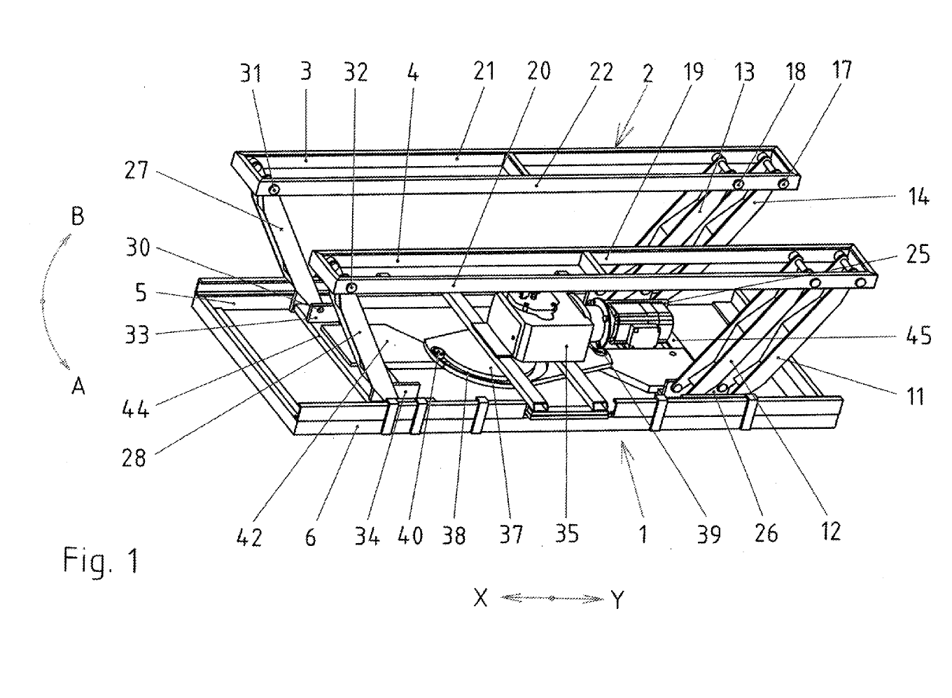

FIG. 1 a lifting table with a raised two-part load pick-up body (without load);

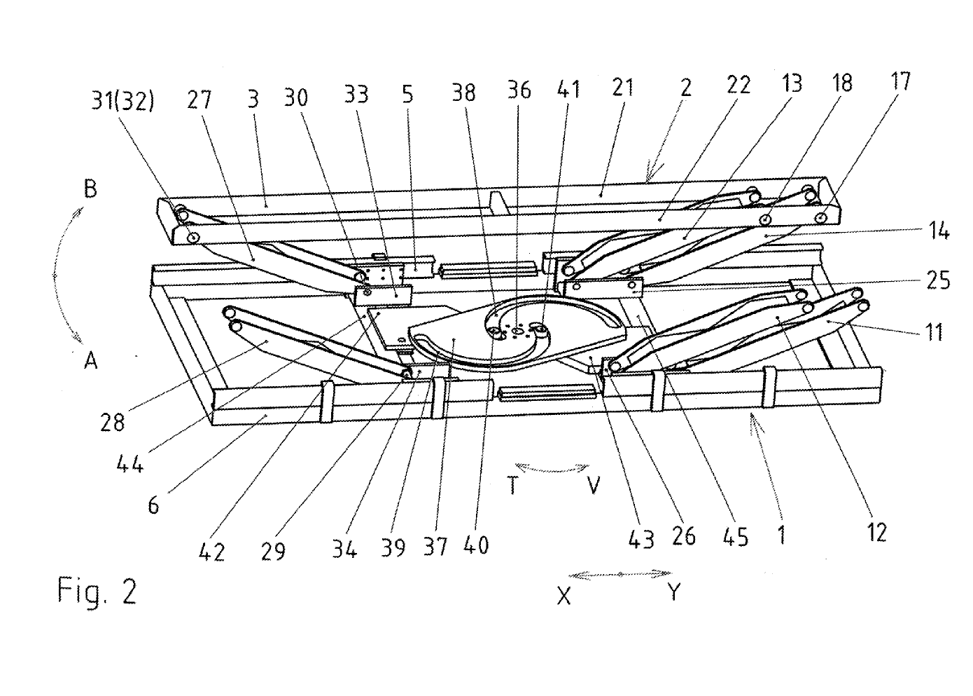

FIG. 2 the lifting table shown in FIG. 1 with the partially lowered load pick-up body (only shown in part);

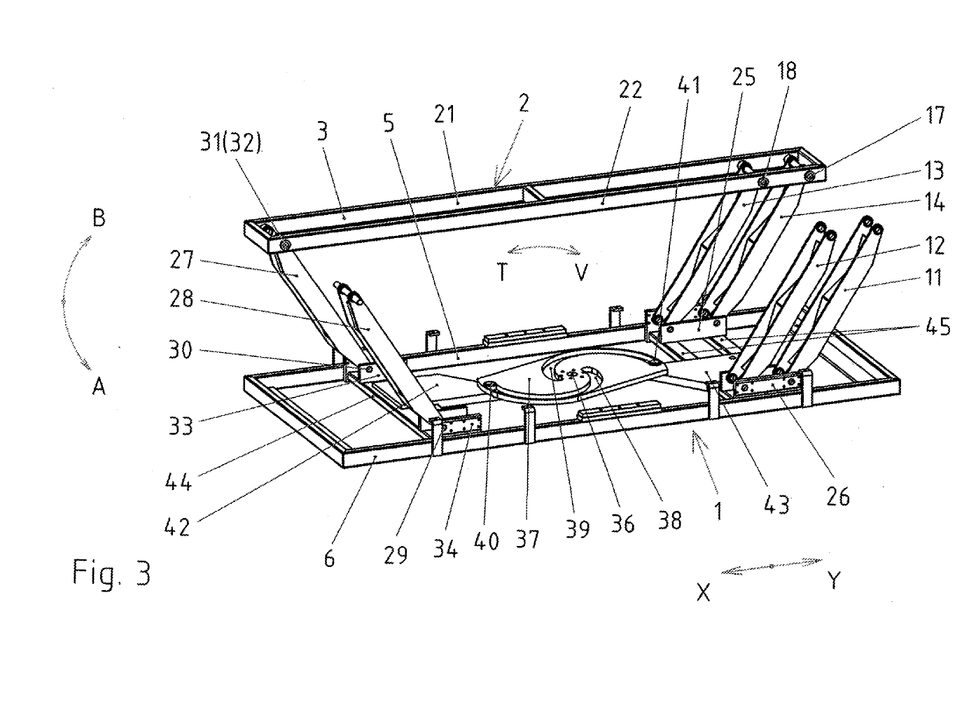

FIG. 3 the lifting table from FIG. 1 wherein some details have been removed;

FIG. 4 the lifting table from FIGS. 1 to 3 in an inclined partially underneath view;

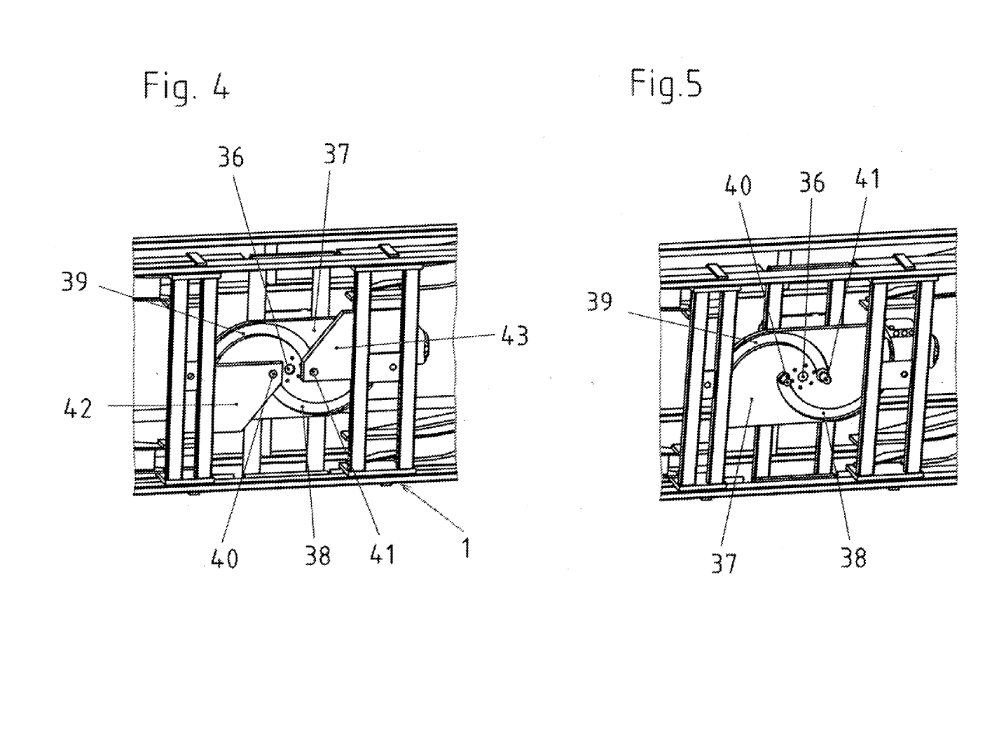

FIG. 5 the lifting table from FIGS. 1 to 4, likewise in an inclined underneath view wherein the two drive bodies are not shown;

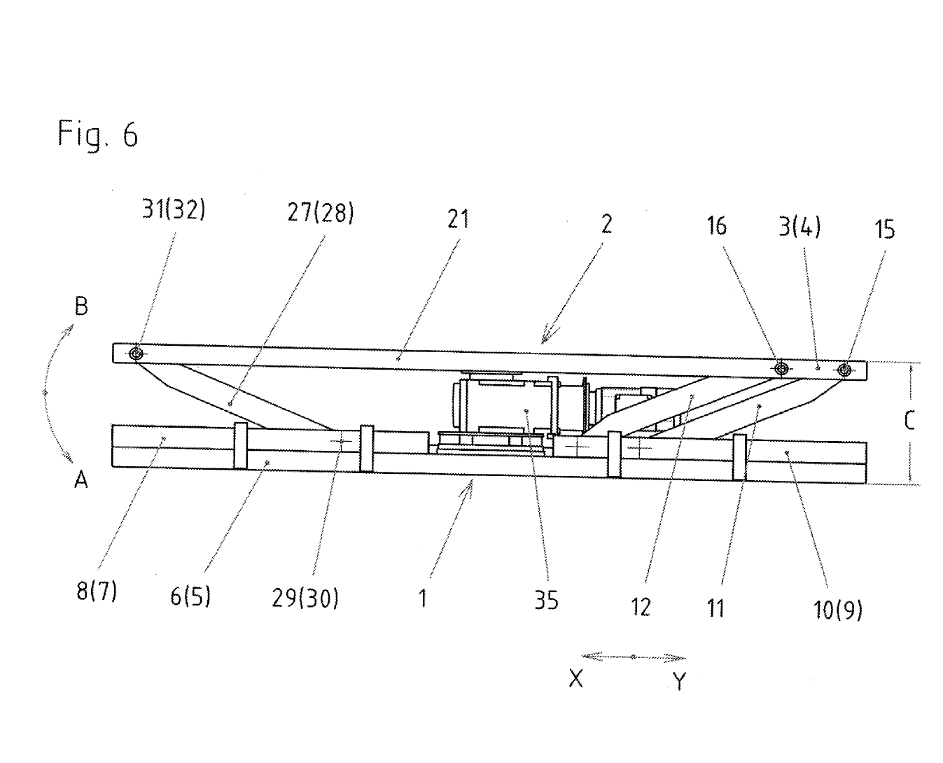

FIG. 6 a side view of the lowered lifting table;

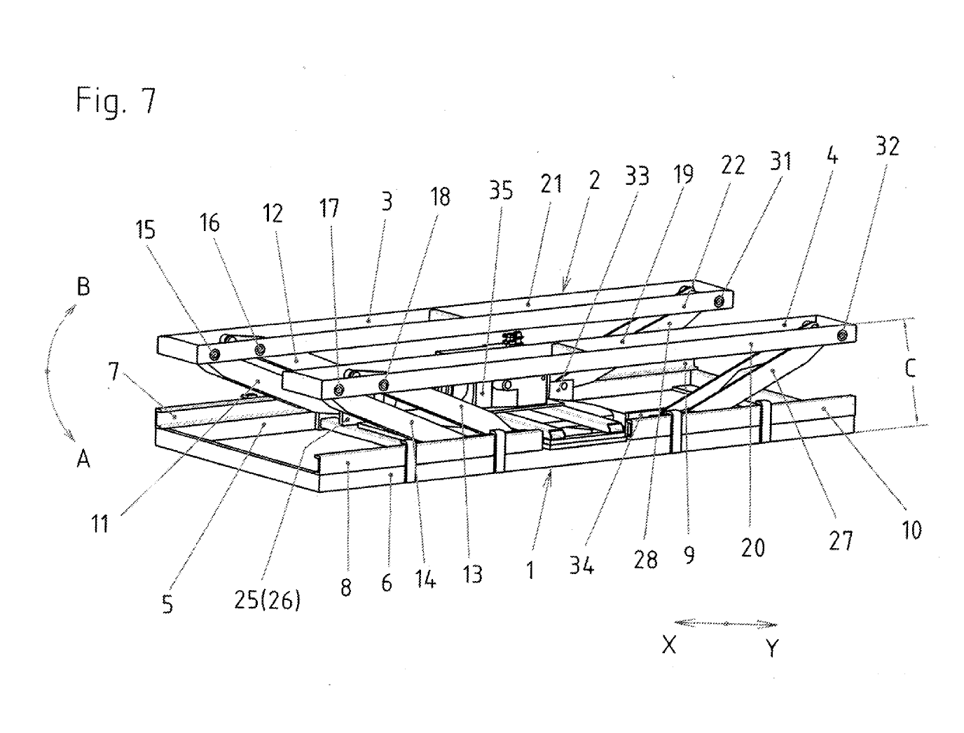

FIG. 7 a perspective view relative to FIG. 6, wherein the lifting table was shown rotated approximately 180° about a vertical axis compared with the illustration in FIG. 6;

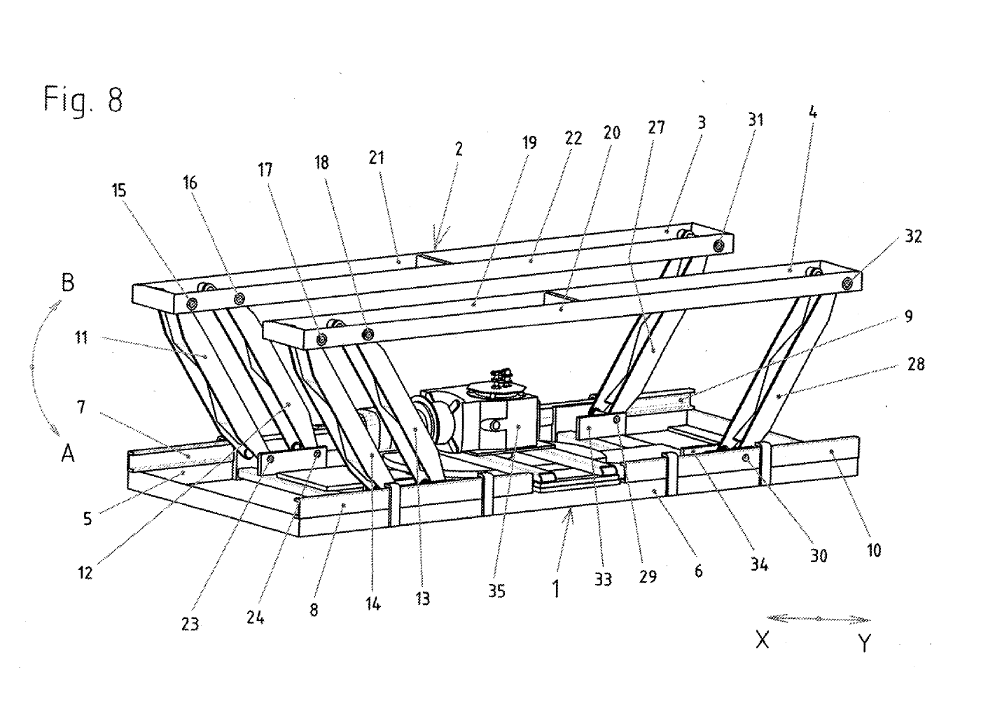

FIG. 8 likewise a perspective view of the lifting table shown in FIG. 7, wherein however compared to

FIG. 7 the load pick-up body was shown as in FIG. 1 in a raised position of the load pick-up body, with a lifting table rotated, compared to FIG. 1, 180° about a vertical axis;

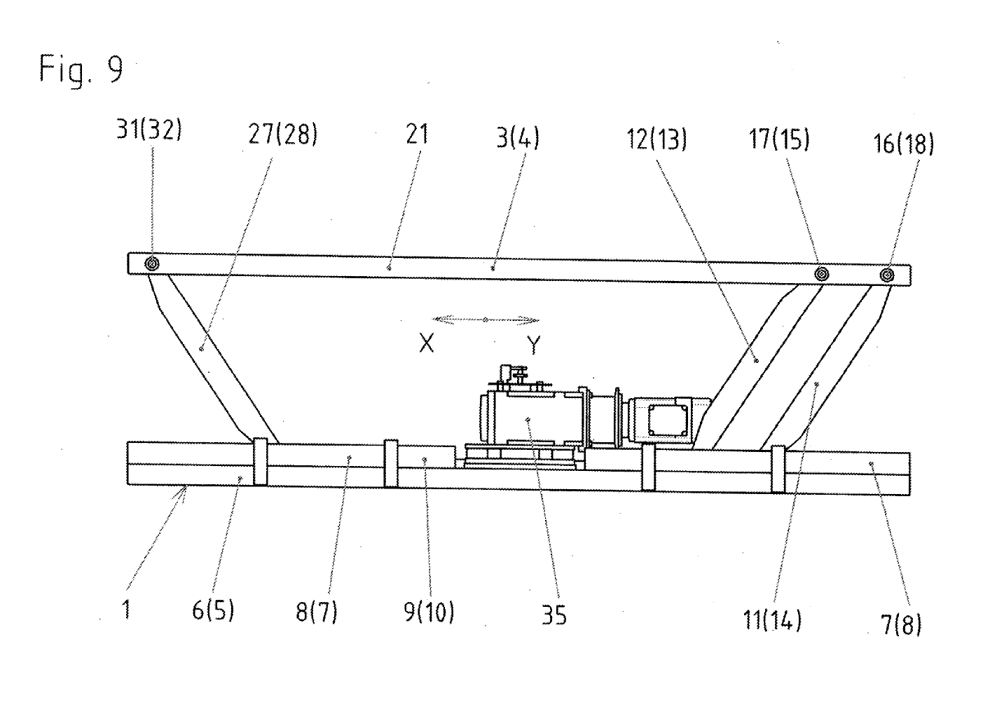

FIG. 9 a side view relative to FIG. 1;

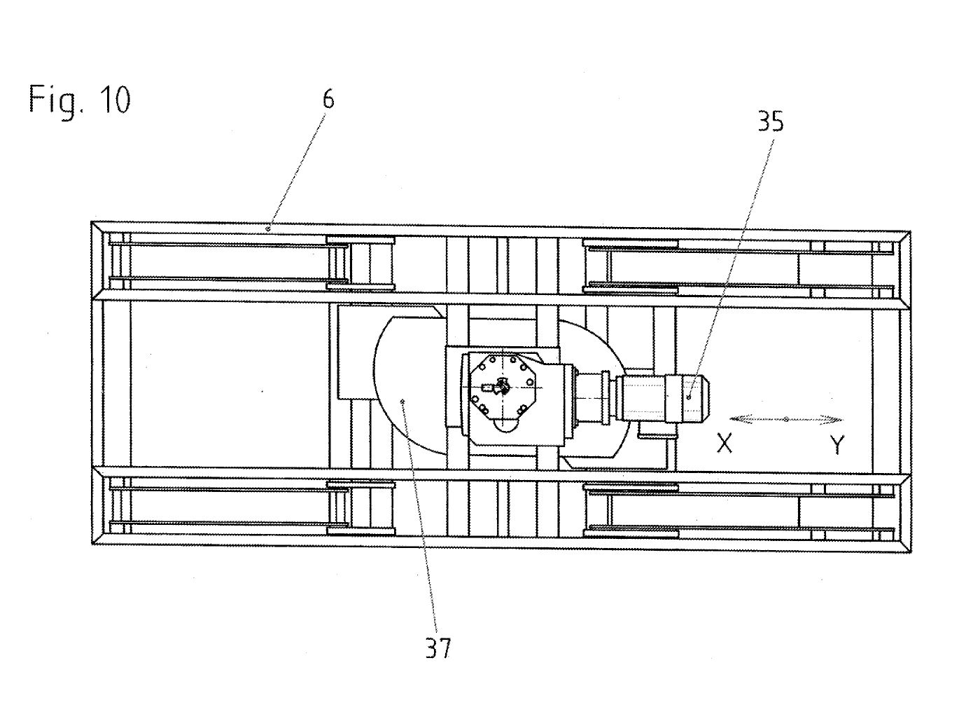

FIG. 10 a plan view of a lifting table;

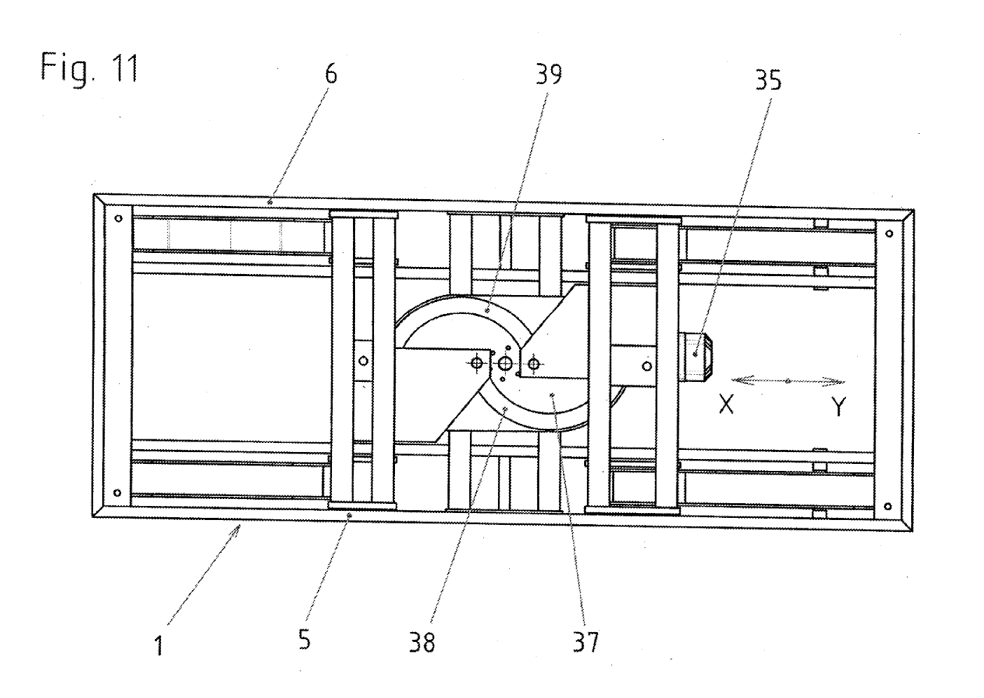

FIG. 11 an underneath view of a lifting table with the load pick-up body located in the raised position; and

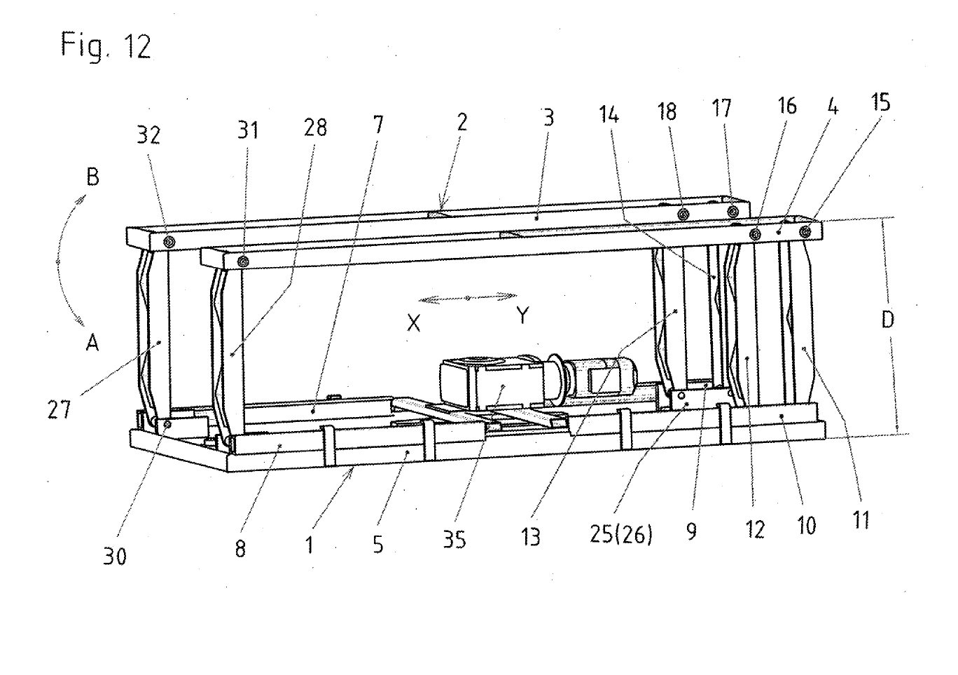

FIG. 12 the lifting table in a fully raised position of the load pick-up body, in a perspective view.

In the drawings a frame-like underframe is marked by reference numeral 1 and a load pick-up body 2 which is vertically adjustable infinitely parallel thereto is marked by reference numeral 2 and in the embodiment illustrated in the drawing consists of two load pick-up body frame parts 3 and 4 which are arranged spaced from and parallel to one another. Instead of two load pick-up body frame parts 3 and 4 it is also possible to provide as the load pick-up body 2 a single frame, where necessary reinforced by cross supports. Both the underframe 1 and also the load pick-up body 2 or load pick-up body frame parts 3, 4 are designed rectangular in the plan view in the illustrated embodiment and consist substantially of profiled elements which can be made of aluminum alloy and/or steel and/or plastics, e.g. of carbon fibers. The individual frame parts of the underframe 1 and the load pick-up body 2 can be connected together functionally or materially in one piece through screws, welding or adhesive—depending on the operating conditions and type of stress, e.g. by screws and/or welding and/or adhesive.

The underframe 1 furthermore has two longitudinal beams 5 and 6 to form the rectangular shape wherein in the illustrated embodiment U-shaped profiled supports 7,8 and 9,10 are arranged in one piece on the longitudinal beams 5 and 6 and each extend over a certain longitudinal area with their U-arms directed towards one another. The U-shaped profiled supports 7, 8 and 9, 10 can be connected functionally or materially in one piece with the longitudinal beams 5, 6 in a suitable way, for example by screws and/welding and/or adhesive.

The frame-like underframe 1 and the frame-like load pick-up body 2 or its load pick-up body frame parts 3 and 4 are connected to one another for pivotal movement by guide rod elements, described below, so that load pick-up body 2 and the underframe 1 are connected to one another for pivotal movement in the vertical plane A or B, which means that the load pick-up body 2, here the load pick-up body frame parts 3 and 4, can be infinitely adjusted vertically relative to one another from a minimum lifting height C (FIGS. 6 and 7) to a maximum lifting height D (FIG. 12) and can be locked at each desired height.

With the illustrated embodiment two guide rod elements 11, 12 and 13, 14 running parallel to one another and spaced apart in the longitudinal axial direction of the underframe 1 are mounted in the area of each one end section of the underframe 1 and thus the load pick-up body 2 on each longitudinal beam 5 and 6 and thus on each longitudinal side of the rectangular underframe 1. The guide rod elements 11, 12 and 13, 14 are each formed with the same length and form parts of a parallelogram gearing. The guide rod elements 11, 12, 13, 14 are connected for pivotal movement in vertical planes A-B at their end areas facing the load pick-up body 2 at the same level each via pivotal axes 15, 16 and 17, 18 with longitudinal beams 19, 20 and 21, 22 of the load pick-up body frame parts 3 and 4. The pivotal axes 15, 16 and 17, 18 can be arranged with minimum friction in rolling bearings, for example in needle bearings. The end areas of the guide rod elements 11, 12 and 13, 14 and the pivotal axes 15, 16 and 17, 18 are arranged between the longitudinal beams 19, 20 and 21, 22 respectively.

At the opposite end sections the guide rod elements 11, 12 and 13, 14 are likewise mounted for pivotal movement in rolling bearings, more particularly in needle bearings, each through a pivotal axis running with its longitudinal axes parallel to the pivotal axes 15, 16 and 17, 18, wherein only the pivotal axes 23 and 24 were marked with reference numerals. The remaining pivotal axes of the guide rod elements 11, 12 and 13, 14 are designed and arranged correspondingly. The pivotal axes 23 and 24, and the remaining pivotal axes (not marked) of the guide rod elements 11-14 are mounted in bearing assemblies 25, 26 which are guided for example in the U-profiles 7, 8 and 9, 10 in their longitudinal axial direction, thus in the direction X and Y respectively in opposite directions and longitudinally displaceable corresponding to the pivotal movement A-B of the load pick-up body 2 displaceable during pivotal movement of the guide rod elements 11, 12 and 13, 14.

The guide rod elements 11, 12 and 13, 14 can have in cross-section a box-shaped, U-shaped or where necessary polygonal cross-section and like all the remaining profiled parts can consist of aluminum alloy and/or steel and/or carbon fibers and/or plastics, e.g. have a honeycomb structure internally for minimizing weight.

At their end section opposite the guide rod elements 11, 12 and 13, 14 the underframe 1 is coupled for pivotal movement in the vertical plane A and B on each longitudinal side each by a guide rod element 27, 28 each via a pivotal axis 29, 30 running parallel to the pivotal axes 15, 16 and 17, 18 to the underframe 1 and via pivotal axes 31 and 32 running with their longitudinal axes parallel to the pivotal axes 29, 30 each to one of the load pick-up body frame parts 3 and 4. As can be seen from the drawings, the guide rod elements 11, 12 and 13, 14 are arranged inclined from the perpendicular in an opposed manner with respect to the longitudinal axes of the guide rod elements 27, 28 so that during lowering of the load pick-up body 2 into the minimal vertical position C the load pick-up body 2 can be lowered to a slight distance parallel to the underframe 1.

The pivotal axes 29 and 30 of the guide rod elements 27 and 28 are likewise mounted in bearing assemblies 33 and respectively. The bearing assemblies 33, 34 can be designed and arranged like the bearing assemblies 25 and 26, by way of example can be arranged displaceable in the longitudinal axial direction in or on or at U-shaped profiled supports 9 and 10. Both the bearing assemblies 25, 26 and also the bearing assemblies 33 34 can be mounted with minimum friction, for example by rolling bearings or slide bearings. As the load pick-up body 2 is pivoted up and down the bearing assemblies 25, 26 on the one hand and the bearing assemblies 33, 34 on the other are moved oppositely relative to one another in a straight line, which means that during downward pivoting of the load pick-up body parts 3, 4 the bearing assemblies 25, 26 on the one hand are moved synchronously and at the same speed towards one another opposite the bearing assemblies 33, 34 and during upward pivotal movement are moved in a straight line away from one another.

The reference numeral 35 designates a drive motor which in the illustrated embodiment is designed as an electrically driven gear motor with reversible rotational direction. However other drive motors can also be considered for driving the lifting table, for example a piston-cylinder unit which can be pressurized alternately on each side with a pressurized medium pressure, for example hydraulically, or a hydrostatic drive or the like. The gear motor 35 of the embodiment illustrated by way of example and to be supplied with electric energy is coupled gearwise via a flange and a drive shaft 36 to a gear body 37 which is mounted for rotational movement by the drive motor 35 in a horizontal plane, thus parallel to the installation floor of the lifting table to move around for example approximately 90° in opposite directions. The gear body 37 is mounted in the space between the longitudinal beams 5, 6 of the underframe 1 and above same, thus above the installation floor. As can be seen from the drawing, the gear body 37 has an approximately plate-like design, of approximately rectangular shape, wherein the narrow sides of the rectangle are designed more acute or tapered and are finished off materially and are shown defined by different wall parts. Obviously the invention is not restricted to this design shape of the gear body 37. The gear body 32 could also be formed circular or elliptical or square or trapezoidal or polygonal.

The gear body 37 has curved slide recesses 38 and 39 arranged diametrically relative to the drive shaft 36 of the drive motor 35. The slide recesses 38 and 39 copy the acceleration and speed profile with which the guide rod elements 11 to 14 on the one hand and 27 and 28 on the other are pivoted and thus execute the lifting movement in the direction A and B respectively of the load pick-up body 2. The slide recesses 38, 39 can in marginal cases be circular arcs, but can also have another configuration according to which speed or acceleration profile is selected for the lifting movements of the load pick-up body 2.

A slide follower body 40, 41 engages with positive connection, but minimum friction, in the curved slide recesses 38 and 39 respectively, which pass through the gear body 37. The slide follower bodies 40 and 41 are currently designed here as rolling bolts which are mounted with minimum friction for example in rolling bearings, more particularly in needle bearings, and are guided with rolling action on the walls of the curved slide recesses 38 and 39.

The bolt-like slide follower bodies 40, 41 are arranged in one piece, but interchangeable for example, on special plate-like drive bodies 42 and 43 respectively. The drive bodies 42 and 43 are located in a plane underneath the gear body 37 and are arranged with their surface parallel to the underneath of the plate-like gear body 37.

Each plate-shaped drive body 42 and 43 is mounted in one piece but detachably on each two cross supports 44 and 45, by way of example by screws, welding or adhesive, but functionally or materially in one piece therewith, wherein these cross supports are also assigned bearing assemblies 25 and 26 on one side and 33, 34 on the other, so that the plate-shaped drive bodies 42, 43 are moved oppositely one another in the direction X and Y during driving of the plate-shaped gear body 37 through the drive motor 35 via the drive bodies 42, 43, since the rotational movements of the drive shaft 36 are transferred via the drive flange of the drive motor 35 associated with the drive shaft to the gear body 37 and via the slide recess 38 and the slide follower bodies 40, 41 to the drive bodies 42 and 43 and thus via the cross supports also to the bearing assemblies 25, 26 and 33, 34 respectively, and thus to the associated guide rod elements 11-14 on the one hand and 27, 28 on the other, and thus to the load pick-up body 2 and the load pick-up body parts 3, 4 respectively. The transmission chain and power transmission to the drive motor are thus closed.

As can be seen, the lifting table according to the invention also enables an eccentric loading without impairing the tilt stability. The double arms at the one end section of the lifting table, formed by the guide rod elements 11, 12 and 13, 14 respectively on one side and the guide rods 27, 28 enable an extremely stable mounting and a precision lifting movement in the direction A and B respectively, even when the lifting table is to be loaded with heavy body work parts, for example in car manufacturing.

T and V designate pivotal and rotary movements respectively.

The features described in the claims and in the description and apparent from the drawings can be essential individually and also in any combination for the implementation of the invention.

### REFERENCE NUMERALS

1 Underframe
2 Load pick-up body
3 Load pick-up body frame part
4 “
5 Longitudinal beam
6 “
7 U-shaped profiled support
8 “
9 “
10 “
11 Guide rod element
12 “
13 “
14 “
15 Pivotal axis
16 “
17 “
18 “
19 Longitudinal beam
20 “
21 “
22 “
23 Pivotal axis
24 “
25 Bearing assembly
26 “
27 Guide rod element
28 “
29 Pivotal axis
30 “
31 “
32 “
33 Bearing assembly
34 “
25 Drive motor
36 Drive shaft
37 Gear body
38 Slide recess
39 “
40 Slide follower body
41 “
42Drive body
43 “
44 Cross support
45 “
A Lifting movement
B “
C Minimum height
D Maximum height
X Lift in longitudinal axial direction
Y “
T Rotational movement

V “

1. Motorized vertically adjustable lifting table, for example for use in body work construction in the motor vehicle industry, with a frame-type underframe associated with the installation floor, and a load pick-up body which is vertically movable relative thereto and which can be moved in the vertical direction relative to the underframe by pivotally movable guide rod elements, with for example two drive bodies which are mounted opposite one another and are associated with the underframe, wherein the drive bodies each have at least one slide follower body at their facing end areas, wherein each drive body is connected—indirectly where applicable—to bearing assemblies for the guide rod elements associated with the underframe and with these bearing assemblies is mounted on the underframe and guided through rectilinear guides in the longitudinal direction thereof, wherein the slide follower bodies each engage through gearing in a curved slide recess of a gear body and the gear body of one slide drive is connected through gearing to a drive motor which can be controlled in opposite rotational or pivotal directions of the gear body, wherein the frame-like load pick-up body is connected in its end areas by horizontal pivotal axes to guide rods which are also connected via horizontal pivotal axes to bearing assemblies which are vertically movable in the longitudinal axial direction of the underframe, wherein at at least one end area on each side of the lifting table two guide rod elements spaced out in the longitudinal axial direction of the underframe and forming parallelogram sides are arranged in pairs for pivotal movement and at the opposite end area of the lifting table on each side at least one guide rod element each is mounted for pivotal movement, wherein the bearing assemblies are connected in one piece for example by cross supports running transversely to the longitudinal axis of the lifting table.

2. Lifting table according to claim 1 characterized in that the curved slide recesses of the gear body copy and thus determine the movement profile of the vertically adjustable load pick-up body.

3. Lifting table according to claim 2 characterized in that the angle pitch of the slide recesses in relation to the center point of a drive shaft of the drive motor which is designed as an electric motor are matched to the initial acceleration and deceleration and the lifting speed of the load pick-up body.

4. Lifting table according to claim 1 characterized in that the curved slide recesses are arranged eccentrically relative to one another in relation to the rotational center of the gear body, e.g. of a drive shaft of the drive motor.

5. Lifting table according to claim 1 characterized in that the curved slide recesses are arranged opposite one another and offset relative to one another in the direction of the pivotal or rotational periphery of the gear body.

6. Lifting table according to claim 1 characterized in that the curved slide recesses pass through the thickness of the gear body.

7. Lifting table according to claim 1 characterized in that the slide follower bodies engaging in the curved slide recesses are designed as pins which engage with positive action, but smooth running and minimum friction in the curved slide recesses.

8. Lifting table according to claim 1 characterized in that the slide follower bodies are designed as roller bolts mounted in rolling bearings and engaging with positive action but smooth running in the curved slide recesses.

9. Lifting table according to claim 1 characterized in that the gear body is plate-shaped.

10. Lifting table according to claim 1 characterized in that the gear body is defined on opposite sides by flat surfaces and is arranged horizontal to the installation floor in the space between the frame-type underframe and the vertically movable load pick-up body.

11. Lifting table according to claim 1 characterized in that the drive bodies are also designed plate-shaped and each are coupled in one piece both functionally or materially to cross supports associated with frame parts of the underframe and these frame parts are assigned to the bearing assemblies of the underframe.

12. Lifting table according to claim 1 characterized in that the gear body is arranged parallel to the drive bodies and above same in the space between spaced longitudinal beams of the underframe.

13. Lifting table according to claim 1 characterized in that the electric drive motor designed as a gear motor is arranged in the space between the underframe and the vertically movable load pick-up body.

14. Lifting table according to claim 1 characterized in that the plate-shaped drive bodies are connected to cross supports which are guided vertically movable in opposite directions with the bearing assemblies in longitudinal guides in plan view of the for example rectangular frame-like underframe in the longitudinal axial direction thereof.

15. Lifting table according to claim 1 characterized in that in all four end areas of the load pick-up body there are two guide rod elements each spaced out on each longitudinal side of the lifting table.

16. Lifting table according to claim 1 characterized in that the vertically movable load pick-up body has in the area of each longitudinal side of the lifting table two longitudinal beams each, which are coupled by horizontal axes for pivotal movement to the guide rod elements which are arranged on this longitudinal side of the lifting table and are pivotally movable in the vertical plane.

17. Lifting table according to claim 1 characterized in that the guide rod elements which connect the frame-like underframe and the frame-like load pick-up body are mounted for pivotal movement in bearing assemblies which are associated with the frame-like underframe and which are displaceable in opposite directions in U-shaped longitudinal guides of the frame-like underframe in its longitudinal axial direction in opposite directions during pivotal movement of the slide follower bodies via the drive bodies, and are lockable in the relevant desired lifting position of the load pick-up body.

18. Lifting table according to claim 1 characterized in that the gear body in plan view has an approximately rectangular configuration in the corner areas of which on diagonally opposite sides are arranged the curved slide recesses which extend at their one end area up to roughly the rotational center point of the drive shaft of the drive motor and with each other end area extend curved into an outer corner area of the gear body.
